(19) United States
(12) Patent Application Publication
(10) Pub. No.: US 2009/0117429 A1
(43) Pub. Date: May 7, 2009

(54) DIRECT CARBON FUEL CELL HAVING A SEPARATION DEVICE

(76) Inventors: Andrew J. Zillmer, Woodland Hills, CA (US); Charles Thomas Kudija, Santa Clarita, CA (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/935,739

(22) Filed: Nov. 6, 2007

(51) Int. Cl. H01M 8/02; B01D 15/00; B01D 17/00

(52) U.S. Cl. 429/26; 210/660; 210/702; 210/767; 429/12; 429/34

(57) ABSTRACT

A direct carbon fuel cell includes a vessel having a liquid anode region and a separation device connected with the liquid anode region for separating constituents from a liquid anode material circulating through the liquid anode region.

### BACKGROUND OF THE INVENTION

This invention relates to direct carbon fuel cells and purifying a liquid anode material of the fuel cell.

Direct carbon fuel cells utilize an electrochemical reaction to generate electricity from carbon. For example, conventional direct carbon fuel cells include an electrolyte that separates a molten anode from a cathode having an oxygen source (e.g., air). The electrolyte electrochemically reduces the oxygen to produce oxygen ions that migrate through the electrolyte. The molten anode delivers fuel (e.g., carbon) to the electrolyte. The carbon reacts with the ionized oxygen to produce carbon dioxide and electrons that flow through an external circuit and back to the cathode to thereby provide electric current.

### SUMMARY OF THE INVENTION

The disclosed direct carbon fuel cells and methods are for facilitating purification of a liquid anode material of the fuel cell.

An example direct carbon fuel cell includes a vessel having a liquid anode region and a separation device connected with the liquid anode region for separating constituents from a liquid anode material circulating through the liquid anode region.

An example method of purifying a liquid anode material of a direct carbon fuel cell includes circulating a liquid anode material through a liquid anode region and separating constituents from the liquid anode material to thereby purify the liquid anode material.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates an example direct carbon fuel cell having a circulation passage and a separation device for removing constituents from a liquid anode material.

FIG. 2 illustrates a cross-sectional view of the direct carbon fuel cell of FIG. 1.

FIG. 3 illustrates another embodiment direct carbon fuel cell having a plurality of separation devices within a circulation passage.

FIG. 4 illustrates another embodiment of a direct carbon fuel cell including a turbulator as the separation device.

FIG. 5 illustrates another embodiment of a direct carbon fuel cell including a turbulator within an additional chamber of a direct carbon fuel cell.

FIG. 6 illustrates another embodiment direct carbon fuel cell including a heater as the separation device.

FIG. 7 illustrates another embodiment direct carbon fuel cell including a concentric tube arrangement as the separation device.

FIG. 8 illustrates another embodiment direct carbon fuel cell including a catalyst as the separation device.

FIG. 9 illustrates another embodiment direct carbon fuel cell having a getter device as the separation device.

### DETAILED DESCRIPTION OF THE PREFERRED EMBODIMENT

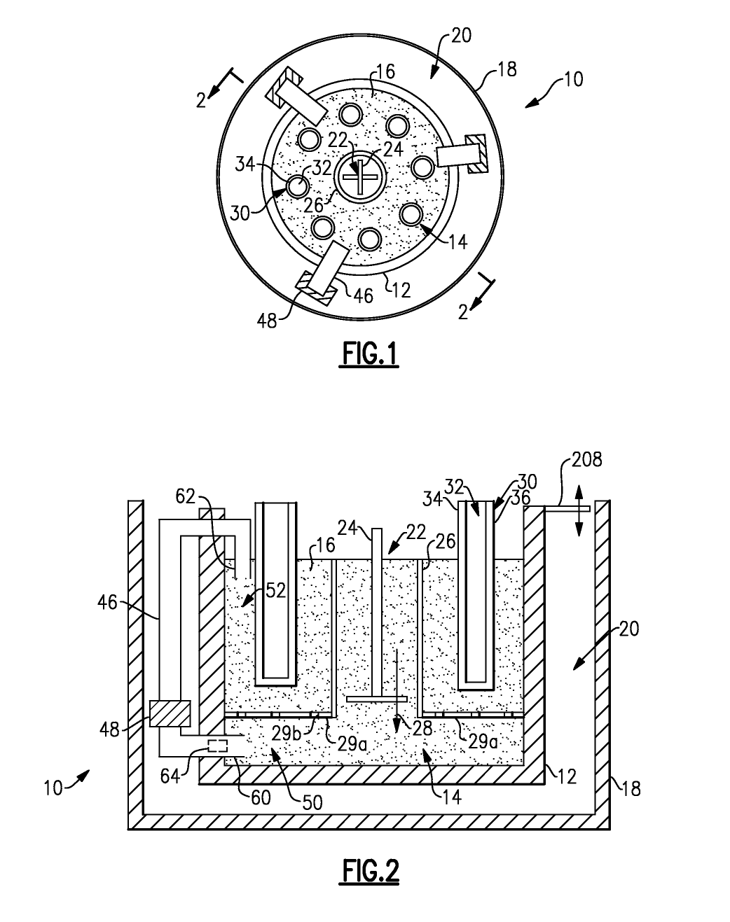

FIG. 1 illustrates selected portions of an example direct carbon fuel cell 10 for generating electricity from a carbon fuel. For example, the direct carbon fuel cell 10 may be used in a vehicle, a stationary power supply, or other type of application and utilize an input of a carbon-containing material (e.g., coal, carbon-based feedstock, etc.) as the fuel. As can be appreciated, the direct carbon fuel cell 10 discloses a particular fuel cell arrangement; however, the examples disclosed herein are applicable to other direct carbon fuel cell arrangements and are not limited to the illustrated arrangement. As will now be discussed, the direct carbon fuel cell 10 facilitates purification of a liquid anode material to maintain or increase efficient operation of the fuel cell 10.

Referring also to FIG. 2, the direct carbon fuel cell 10 includes a vessel 12 that generally defines a liquid anode region 14 therein. As shown, the vessel 12 has an open top, but alternatively may be sealed from the surrounding environment. The liquid anode region 14 defines a space for a liquid anode material 16, which will be described more fully below. The vessel 12 is contained within a somewhat larger chamber 18 such that there is a space 20 between the walls of the chamber 18 and the walls of the vessel 12. Relatively cool gas may be circulated through the space 20 to control a temperature of the vessel 12.

The direct carbon fuel cell 10 also includes a pump 22 for circulating the liquid anode material 16 through the liquid anode region 14. The pump 22 includes a circulator 24 that reciprocates within a downcomer 26, as represented by arrow 28. The circulator 24 may also rotate to further circulate the liquid anode material 16. As can be appreciated, the other types of pumps may be used. Additionally, the direct carbon fuel cell 10 may include a distribution plate 29a having gaps 29b for enhancing uniform circulation of the liquid anode material 16/

The direct carbon fuel cell 10 also includes a plurality of tubes 30 that extend at least partially into the liquid anode region 14. The tubes 30 include a hollow inner space 32 and a surrounding wall 34. The oxidizer side of the wall 34 may be coated with an electrolyte material 36 for promoting the electrochemical reaction of the direct carbon fuel cell 10. The wall 34 may be formed of a structural material, such as a ceramic, for supporting the electrolyte layer 36. Likewise, the electrolyte material 36 may be any suitable type of electrolyte for a desired type of electrochemical reaction.

In operation, the liquid anode material 16 is maintained at an elevated temperature, which depends on the melting temperature of the type of anode material used. The liquid anode material 16 may be any suitable type of anode material for delivering carbon fuel to the electrolyte material 36. That is, the liquid anode material 16 provides mobility of the carbon fuel to the electrolyte 36. For example, the liquid anode material 16 is a molten salt or glass that is maintained in a liquid state at a temperature of about 700-800° C. (1292-1472° F.). As can be appreciated, the liquid anode material 16 may include other types of anode materials. Thus, the examples disclosed herein are not limited to any particular type of the liquid anode material 16.

At such elevated temperatures, the liquid anode material 16 may chemically attack the structure of the direct carbon fuel cell 10, such as the walls of the vessel 12, which may result in dissolution of constituents into the liquid anode material 16. The feedstock of fuel may also include constituents that dissolve into the liquid anode material 16. The constituents may inhibit delivery of fuel to the electrolyte material 36, inhibit the reaction at the electrolyte material 36, “poison” the electrolyte material 36, or otherwise contribute to less efficient operation of the direct carbon fuel cell 10. In this regard, the direct carbon fuel cell 10 includes a circulation passage 46 and a separation device 48 for separating the constituents from the liquid anode material 16 to thereby purify the liquid anode material 16.

As illustrated, the direct carbon fuel cell 10 includes a plurality of the circulation passages 46 with a corresponding plurality of the separation devices 48. However, it is to be understood that fewer circulation passages 46 and separation devices 48 may be used, or alternatively a greater number of the circulation passages 46 and the separation devices 48 may be used, depending on the needs of a particular system. Furthermore, in some examples, the separation device 48 may be incorporated into the vessel 12 without using the circulation passage 46.

The liquid anode region 14 generally includes a high pressure region 50 and a low pressure region 52. For example, the pump 22 may be used to produce the high pressure region 50 and the low pressure region 52, wherein the area of the liquid anode region 14 near the bottom of the downcomer 26 may be at a higher pressure than areas that are farther away from the outlet of the downcomer 26.

In the illustrated example, the circulation passage 46 includes an inlet 60 that is located near the high pressure region 50 and an outlet 62 that is located near the low pressure region 52. The pressure differential between the high pressure region 50 and the low pressure region 52 causes liquid anode material 16 to circulate through the circulation passage 46 for purification by the separation device 48. In this regard, the liquid anode material 16 that is discharged from the outlet 62 includes a lower concentration of the constituents than liquid anode material 16 entering the inlet 60 of the circulation passage 46. Optionally, the circulation passage 46 may include another pump 64 for facilitating circulation of the liquid anode material 16 through the circulation passage 46.

The separation device 48 may be operated continuously to provide continuous purification of the liquid anode material 16, or intermittently to provide purification at selected times or depending on selected conditions. For example, the separation device 48 may be operated based on a power level of the direct carbon fuel cell 10, based on the type of fuel used, or based on other conditions. At high power levels, the direct carbon fuel cell 10 may generate more heat than at low power levels, which may require removal of the excess heat from the liquid anode material 16 for enhanced efficiency. To this end, the separation device 48 may be connected with a central controller of the direct carbon fuel cell 10.

FIG. 3 illustrates another embodiment of a direct carbon fuel cell 100, where like components are represented by like reference numerals. In this example, the direct carbon fuel cell 100 includes a plurality of the separation devices 48 associated with a single one of the circulation passages 46. Although only two of the separation devices 48 are shown in this example, it is to be understood that additional separation devices 48 may be used. For example, the plurality of separation devices 48 may be used to separate a greater amount of the constituents from the liquid anode material 16, or to remove different species of the constituents. Thus, the number and type of separation devices 48 may depend on the type of liquid anode material 16 that is used and the type and amount of constituents that are to be removed.

The separation device 48 of the previous examples may be any suitable type of separation device for separating and removing the constituents from the liquid anode material 16. The following examples illustrate various different types of separation devices 48 and removal/separation mechanisms that may be used. However, the separation device 48 is not limited to these examples, and may include other types of devices and removal/separation mechanisms.

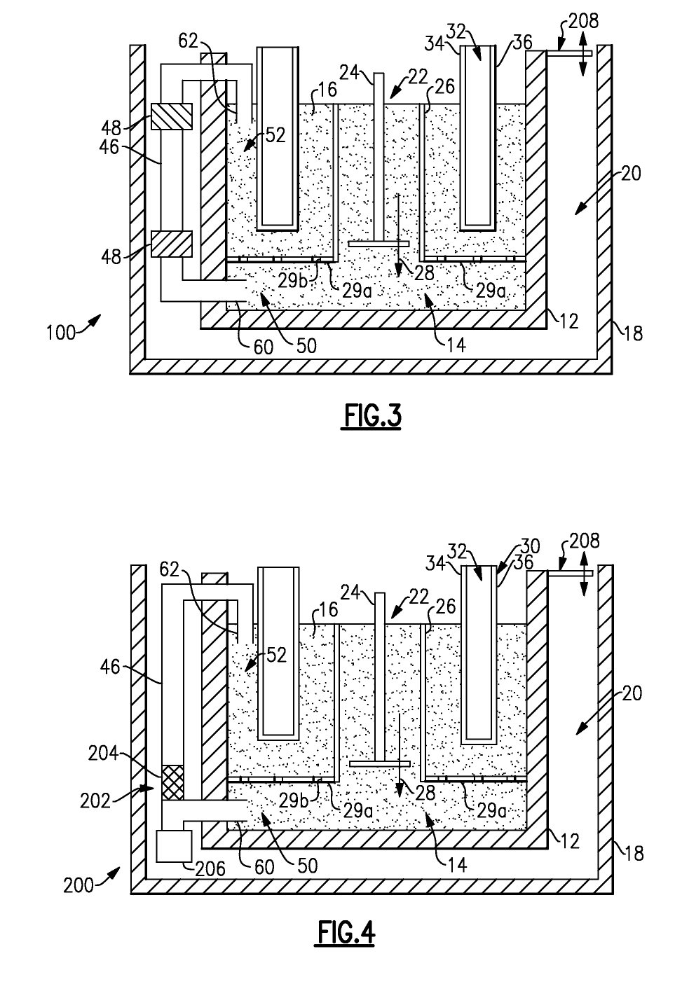

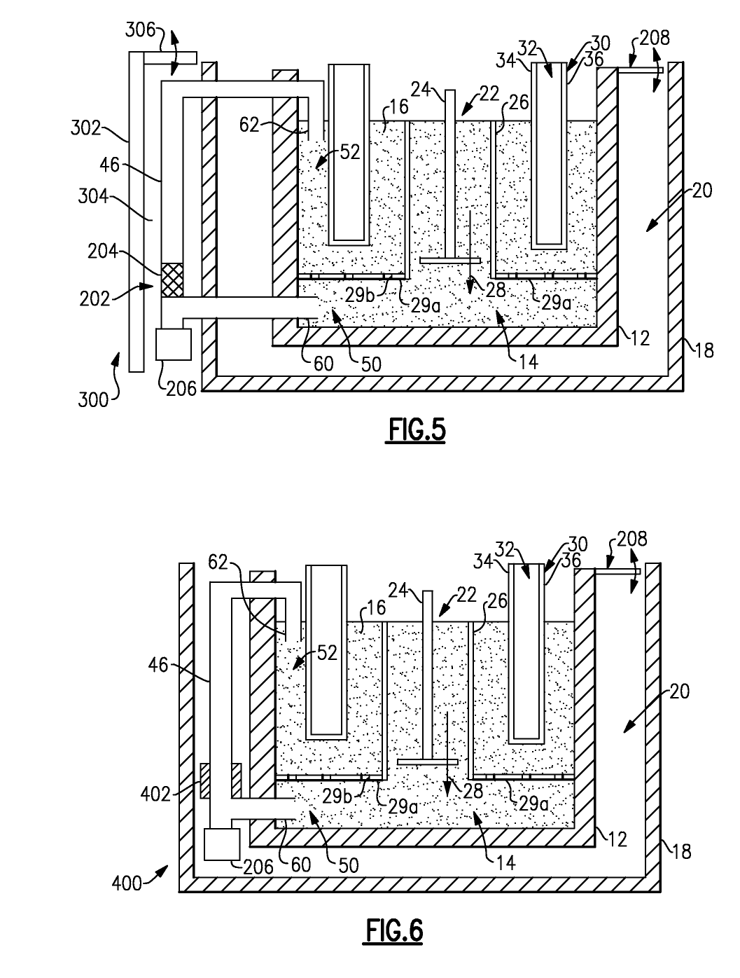

FIG. 4 illustrates an embodiment of a direct carbon fuel cell 200, where like components are represented by like reference numerals. In this embodiment, the direct carbon fuel cell 200 includes a turbulator 202 used as the separation device 48. The turbulator 202 is located within the circulation passage 46, which extends within the space 20 between the vessel 12 and the chamber 18. For example, the turbulator 202 includes a screen 204 within the circulation passage 46. The circulation passage 46 also includes a particle collector 206 located near the bottom of the circulation passage 46.

In operation, the space 20 can be maintained at a relatively cool temperature compared to the temperature of the liquid anode material 16 within the vessel 12. Thus, the space 20 cools the liquid anode material 16 as it circulates through the circulation passage 46 between the inlet 60 and the outlet 62. The cooling causes at least a portion of the constituents to precipitate out from the liquid anode material 16 as solid material, which gravitationally falls to the particle collector 206. The screen 204 of the turbulator 202 provides flow turbulence within the circulation passage 46 that mixes the liquid anode material 16 to facilitate uniform cooling and precipitation.

Additionally, the direct carbon fuel cell 200 may include a damper 208 for regulating a relatively cool gas flow through the space 20. In this regard, the gas flow transfers heat from the circulation passage 46 to thereby cool the liquid anode material 16. The gas flow also cools the vessel 12 to thereby maintain the vessel 12 at a desired temperature for the electrochemical reaction. Thus, the chamber 18 and the space 20 provide a dual function of maintaining the temperature of the vessel 12 and cooling the circulation passage 46.

FIG. 5 illustrates another embodiment direct carbon fuel cell 300, where like components are represented by like reference numerals. In this embodiment, the direct carbon fuel cell 300 includes an additional chamber 302 adjacent the chamber 18 that contains the vessel 12. The circulation passage 46 extends partially through the space 20 of the chamber 18 and also through a space 304 of the chamber 302. The chamber 302 includes a damper 306 for regulating cool gas flow through the chamber 302. Thus, the damper 306 can be used to regulate the temperature of the chamber 302 separately from regulation of the temperature of the chamber 18 using the damper 208. That is, cooling of the liquid anode material 16 circulating through the circulation passage 46 can be independently controlled from cooling of the chamber 18 that is used to regulate the temperature of the vessel 12.

As can be appreciated, the direct carbon fuel cell 200 and the direct carbon fuel cell 300 utilize temperature control to thereby control solubility of the constituents within the liquid anode material 16. That is, by lowering the temperature of the liquid anode material 16, the solubility of at least some of the constituents in the liquid anode material 16 decreases and drives precipitation of the constituents out of the liquid anode material 16 as solid material.

FIG. 6 illustrates another embodiment direct carbon fuel cell 400, where like components are represented by like reference numerals. In this embodiment, the direct carbon fuel cell 400 includes a heater 402 that is used as the separation device 48. The heater 402 is thermally connected with the circulation passage 46 such that the heater 402 may be used to increase the temperature of the liquid anode material 16 circulating through the circulation passage 46. The increase in temperature drives reaction of the constituents within the liquid anode material 16 to form solid material that then gravitationally falls to the particle collector 206. For example, the constituents may react with each other, or other species of constituents within the liquid anode material. Thus, the use of the heater 402 to react the constituents may depend upon the type of constituents within the liquid anode material 16 and the sensitivity of the reactivity of the constituents to temperature change.

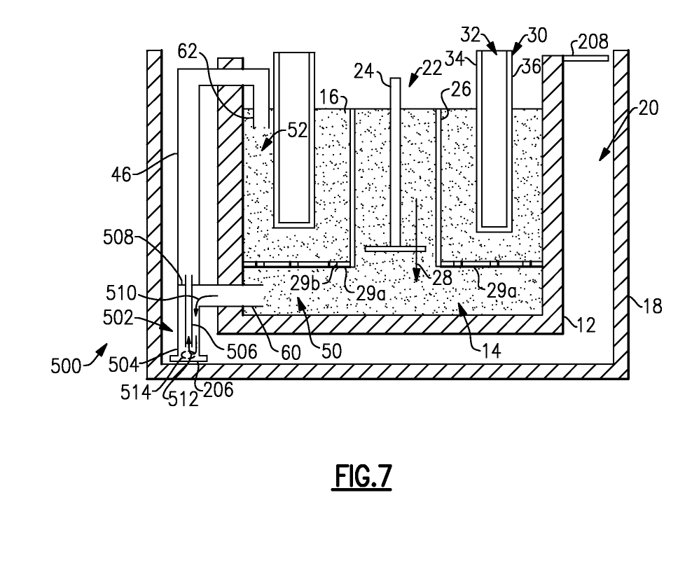

FIG. 7 illustrates another embodiment direct carbon fuel cell 500, where like components are represented by like reference numerals. In this embodiment, the direct carbon fuel cell 500 includes a concentric tube arrangement 502 that is used as the separation device 48. The concentric tube arrangement 502 forms a portion of the circulation passage 46 and includes an outer tube 504 and an inner tube 506. A wall 508 between the outer tube 504 and the inner tube 506 permits upward flow of the liquid anode material 16 only through the inner tube 506. Thus, liquid anode material 16 entering the circulation passage 46 through the inlet 60 flows downwards between the outer tube 504 and the inner tube 506 as represented by arrow 510. Near the bottom of the concentric tube arrangement 502, the liquid anode material 16 turns upwards into the inner tube 506, as represented by arrow 512.

As the liquid anode material 16 turns upwards through the inner tube 506, the velocity decreases such that there is a relatively stagnant region 514 near the peak of the turn 512. The stagnant region 514 corresponds to the coolest portion of the concentric tube arrangement 502. The cool temperature coupled with the low velocity of the liquid anode material 16 in the stagnant region 514 causes at least a portion of the constituents to precipitate from the liquid anode material 16 as a solid material. The solid material that has a higher density than the anode liquid gravitationally falls to the particle collector 206. As can be appreciated, the concentric tube arrangement 502 may be located elsewhere along the circulation passage 46 relative to the inlet 60 and the outlet 62 to provide a desired amount of cooling or a particular location for the stagnant region 514.

FIG. 8 illustrates another embodiment direct carbon fuel cell 600, where like components are represented by like reference numerals. In this embodiment, the direct carbon fuel cell 600 includes a catalyst 602 as the separation device 48. The catalyst 602 is located within the circulation passage 46 such that the catalyst 602 is exposed to circulating liquid anode material 16. The catalyst 602 reacts with at least a portion of the constituents within the liquid anode material 16 to form a gaseous byproduct that buoyantly separates from the liquid anode material 16 to the space above the liquid anode region 14.

As can be appreciated, the catalyst 602 may be any suitable type of catalytic material for reacting constituents of the liquid anode material 16. For example, the catalytic material has sufficient reactivity with at least a portion of the constituents and has little or no reactivity with the liquid anode material 16, carbon fuel, or other constituents of the liquid anode material 16 that are not desired to be removed.

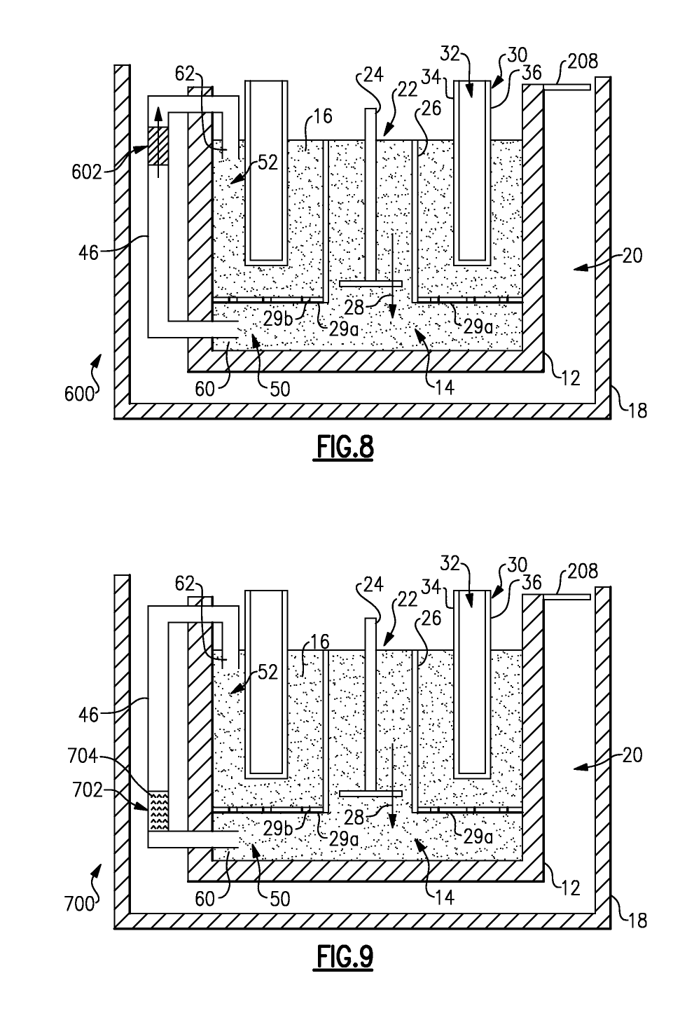

FIG. 9 illustrates another embodiment direct carbon fuel cell 700, where like components are represented by like reference numerals. In this example, the direct carbon fuel cell 700 includes a getter device 702 as the separation device 48. The getter device 702 includes a getter material 704 that contacts the liquid anode material 16 as it circulates through the circulation passage 46. The getter material 704 adsorbs constituents from the liquid anode material 16 to thereby separate the constituents out of the liquid anode material 16. As can be appreciated, any suitable type of getter material 704 may be used, depending upon the type of liquid anode material 16 selected for use in the direct carbon fuel cell 700. For example, the constituents may be present within the liquid anode material in a gaseous form or as a dissolved substance that is then captured by the getter material 604.

The disclosed example direct carbon fuel cells 10, 100, 200, 300, 400, 500, 600, and 700 thereby facilitate purifying the liquid anode material 16. Each of the examples includes at least one separation device 48 that separates the constituents from the liquid anode material 16 and the circulation passage 46 to thereby purify the liquid anode material 16. As also can be appreciated from FIG. 3, the above examples are not limited to using a single type of separation device 48 and may include a plurality of turbulators 202, heaters 402, concentric tube arrangements 502, catalysts 602, and getter devices 702 used in combination, depending upon the amount of constituents to be removed and the type of constituents that are expected to be within the liquid anode material 16.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A direct carbon fuel cell comprising:
a vessel having a liquid anode region; and
a separation device connected with the liquid anode region for separating constituents from a liquid anode material circulating through the liquid anode region.

2. The direct carbon fuel cell as recited in claim 1, further comprising a circulation passage connected with the liquid anode region, wherein the separation device is connected with the circulation passage.

3. The direct carbon fuel cell as recited in claim 2, wherein the liquid anode region comprises a high pressure region and a low pressure region, and wherein the circulation passage includes an inlet proximate to the high pressure region and an outlet proximate to the low pressure region.

4. The direct carbon fuel cell as recited in claim 2, further comprising a cooling chamber, wherein the circulation passage extends through the cooling chamber.

5. The direct carbon fuel cell as recited in claim 4, wherein the vessel is within the cooling chamber.

6. The direct carbon fuel cell as recited in claim 1, wherein the separation device includes a turbulator.

7. The direct carbon fuel cell as recited in claim 6, wherein the turbulator comprises a screen.

8. The direct carbon fuel cell as recited in claim 1, wherein the separation device comprises a concentric tube arrangement.

9. The direct carbon fuel cell as recited in claim 1, wherein the separation device comprises a heater.

10. The direct carbon fuel cell as recited in claim 1, wherein the separation device comprises a getter material.

11. The direct carbon fuel cell as recited in claim 1, wherein the separation device comprises a catalyst.

12. The direct carbon fuel cell as recited in claim 1, wherein the separation device comprises a plurality of devices selected from a turbulator, a concentric tube arrangement, a heater, a getter device, and a catalyst.

13. The direct carbon fuel cell as recited in claim 1, further comprising a pump for circulating the liquid anode material.

14. The direct carbon fuel cell as recited in claim 1, further comprising a gravitational particle collector.

15. The direct carbon fuel cell as recited in claim 1, wherein the liquid anode region comprises a liquid anode material comprising a molten salt and carbon.

16. A method of purifying a liquid anode material of a direct carbon fuel cell, comprising:
circulating a liquid anode material through a liquid anode region; and
separating constituents from the liquid anode material to thereby purify the liquid anode material.

17. The method as recited in claim 16, further comprising circulating the liquid anode material through a circulation passage having a separation device for separating the constituents.

18. The method as recited in claim 16, further comprising precipitating the constituents from the liquid anode material.

19. The method as recited in claim 16, further comprising cooling the liquid anode material.

20. The method as recited in claim 16, further comprising controlling a solubility of the constituents in the liquid anode material.

21. The method as recited in claim 16, further comprising reacting the constituents with a catalyst to form a gas.

22. The method as recited in claim 16, further comprising adsorbing the constituents onto a getter device.
